(19) United States
(12) Patent Application Publication
(10) Pub. No.: US 2019/0311440 A1
(43) Pub. Date: Oct. 10, 2019

(54) SYSTEMS AND METHODS FOR COORDINATING SERVICES IN A PRIVATE ONLINE NETWORK

(71) Applicant: The Hug App Pty Ltd, Melboume (AU)

(72) Inventor: Simon Bishop, Melbourne (AU)

(21) Appl. No.: 16/085,856

(22) PCT Filed: Mar. 17, 2017
(86) PCT No.: PCT/AU2017/050237

§ 371 Date: Sep. 17, 2018

(30) Foreign Application Priority Data
Mar. 17, 2016 (AU) 2016900999

(51) Int. Cl. G06Q 50/00; G06Q 10/10; H04L 29/06

(52) U.S. Cl. CPC G06Q 50/01; H04L 63/0876; G06Q 10/1093

(57) ABSTRACT

Systems and methods are provided for facilitating assistance for services from users within a private online network of users. A web interface is provided for creating and maintaining a private online network of users seeking or offering assistance in relation to predetermined services. The users have verifiable detail common to another user of the private online network. Access is then provided to the interface. An electronic request is transmitted from a mobile device of a first user to mobile devices of other users in the network. Other users are able to accept the request. Upon acceptance of the request, the server generates an electronic event for the assistance.

### CROSS-REFERENCE TO RELATED APPLICATIONS

This application is the United States national phase of International Application No. PCT/AU2017/050237 filed Mar. 17, 2017, and claims priority to Australian Patent Application No. 2016900999 filed Mar. 17, 2016, the disclosures of which are hereby incorporated in their entirety by reference.

### FIELD OF THE INVENTION

The present invention relates to requesting and offering assistance for services in an online environment and in particular to systems and methods for coordinating services in a private online network. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

Many parents in paid employment struggle with the day to day management of their responsibilities when it comes to the care and transport of their children. Outside of family members their network of trusted assistance is simply not wide enough or adequate. There is currently no specific and transaction-centric platform that easily and efficiently assists parents with these responsibilities.

While many parents become acquaintances and sometimes friends with other parents of their children's classmates, the relationship is often not of a nature where the parent feels they could ask for such a favour when it comes to care and transport.

Often when requesting such a favour, a parent may need to contact many family members or friends before they can confirm that their child can be picked up from school or cared for, while they fulfil their employment responsibilities. This comes at a direct cost through time, money and emotion.

The inventor has identified an advantage in utilising communication between mobile devices and online networks of users to facilitate assistance with services such as childcare to other users.

### SUMMARY OF THE INVENTION

In accordance with a first aspect of the present invention there is provided a method for facilitating assistance for services from users within a private online network of users, the method being performed by one or more processors of a server and including:
providing a web interface for creating and maintaining a private online network of users seeking or offering assistance in relation to one or more predetermined services, the users of the private online network having at least one verifiable detail that is common to at least one other user of the private online network;
providing access to the interface, through mobile devices, for allowing users to:
   (i) select a predetermined type of service, a service time and a predetermined service location from menus of the interface, the predetermined service locations corresponding to physical addresses of relevant sites of service and/or physical addresses of the users of the private online network;
   (ii) transmit, from a first mobile device of a first user of the network to mobile devices of other users in the network, an electronic request or offer for assistance from the first user, the request or offer including at least the type of service, the service time and the predetermined service location; and
   (iii) transmit, from a second mobile device of a second user of the network to the first mobile device, an electronic acceptance or rejection in response to the electronic request or offer; and
upon acceptance of the electronic request or offer, generating, at the server, an electronic event for the service, the electronic event including the type of assistance, the service time and the predetermined service location.

In one embodiment the electronic event includes an electronic calendar entry. In one embodiment the electronic event includes electronic reminders issued to the second mobile device at predetermined times. In one embodiment the electronic event includes electronic map coordinates for navigating the second user to the predetermined location.

Preferably during a period in which the service is taking place, a GPS module of the second mobile device is activated so as to facilitate tracking of the second user by the first user through the interface.

Preferably steps (i) to (iii) are performed through the interface using only button presses or gestures on predefined menus using touchscreens of the mobile devices.

Preferably, the method includes the step of electronically verifying the identity of each user within the network. In one embodiment electronically verifying the identity of each user includes securely accessing a database of police records. In another embodiment electronically verifying the identity of each user includes assigning a unique identifier to a mobile device of a user and verifying that unique identifier at predetermined times. In a further embodiment electronically verifying the identity of each user includes identifying a registered phone number associated with a user.

In further embodiments electronically verifying the identity of each user includes identifying a verifiable detail of the user that is common to at least one other user of the private online network. Examples of the verifiable details include (i) contact details of at least one other user in the user's address book of their mobile device; (ii) a friendship on a social media platform with at least one other user of the private online network; and (iii) a physical address linked to the user's child which is common with a physical address linked to a child of at least one other user of the private online network.

In some embodiments the private online network includes parents of children attending a particular school and wherein the predetermined service locations include a physical address of the school. In these embodiments the type of assistance includes picking up or dropping off children of the users from the predetermined service locations. The type of assistance could further include minding a child of a user within the network at a predetermined location for a predetermined period of time. In some embodiments the electronic request or offer also includes a name of the child.

In some embodiments the type of service includes picking up or dropping off a user from one of the predetermined service locations.

Preferably each user has a user profile that is linked with a corresponding payment facility for making and receiving payments of credits upon completion of the requested assistance. In one embodiment the electronic offer includes an offer price for assisting with the service. Preferably, upon completion of the service, a first amount of credits is deducted from the payment facility of one user and a second amount of credits is paid to the payment facility of another user. Preferably the first amount is greater than the second amount and the second amount is equal to the offer price. In some embodiments the credits are units of an online currency.

Preferably the menus of the interface do not require input of text from a user.

In accordance with a second aspect of the present invention there is provided system for facilitating assistance for services from users within a private online network of users, the system including:
a server hosting a web interface for creating and maintaining a private online network of users seeking or offering assistance in relation to one or more predetermined services, the users of the private online network having at least one verifiable detail that is common to at least one other user of the private online network:
a plurality of mobile devices for accessing the web interface to allow users to:
   (i) select a predetermined type of service, a service time and a predetermined service location from menus of the interface, the predetermined service locations corresponding to physical addresses of relevant sites of service and/or physical addresses of the users of the private online network;
   (ii) transmit, from a first mobile device of a first user of the network to mobile devices of other users in the network, an electronic request or offer for assistance with the service from the first user, the request or offer including at least the type of service, the service time and the predetermined service locations; and
   (iii) transmit, from a second mobile device of a second user of the network to the first mobile device, an electronic acceptance or rejection in response to the electronic request or offer; and
wherein, upon acceptance of the electronic request or offer, the server generates an electronic event for the service, the electronic event including the type of assistance, the service time and the predetermined service location.

In accordance with a third aspect of the present invention there is provided a method for requesting assistance for services from users within a private online network of users, the method being performed by one or more processors of a server and including:
providing a web interface for creating and maintaining a private online network of users seeking or offering assistance in relation to one or more predetermined services, the users of the private online network having at least one verifiable detail that is common to at least one other user of the private online network;
providing access to the interface, through mobile devices, for allowing users to:
   (i) select a predetermined type of service, a service time and a predetermined service location from menus of the interface, the predetermined service locations corresponding to physical addresses of relevant sites of service and/or physical addresses of the users of the private online network;
   (ii) transmit, from a first mobile device of a first user of the network to mobile devices of other users in the network, an electronic request for assistance from the first user, the request including at least the type of service, the service time and the predetermined service location;
   (iii) transmit, from a second mobile device of a second user of the network to the first mobile device, an electronic offer in response to the electronic request; and
   (iv) upon receiving the electronic offer, transmit, from the first mobile device to the second mobile device, an acceptance or rejection of the electronic offer; and
upon acceptance of the electronic offer, generating, at the server, an electronic event for the service, the electronic event including the type of assistance, the service time and the predetermined service location.

In accordance with a fourth aspect of the present invention there is provided a method for requesting a vehicle pick-up service from users within a private online network of users, the method being performed by one or more processors of a server and including:
providing a web interface for creating and maintaining a private online network of users seeking or offering assistance in relation to a vehicle pick-up service, the users of the private online network having at least one verifiable detail that is common to at least one other user of the private online network;
providing access to the interface, through mobile devices, for allowing users to:
   (i) select a drop-off location from a list of predetermined drop-off locations within a menu of the interface, the predetermined drop-off locations corresponding to physical addresses of relevant sites of service and/or physical addresses of the users of the private online network;
   (ii) transmit, from a first mobile device of a first user of the network to mobile devices of other users in the network, an electronic request for assistance from the first user, the request including at least the predetermined drop-off location and a pick-up location obtained from a GPS signal of a GPS device embedded within the first mobile device;
   (iii) transmit, from a second mobile device of a second user of the network to the first mobile device, an electronic acceptance or rejection in response to the electronic request or offer; and
upon acceptance of the electronic request or offer, generating, at the server, an electronic event for the service, the electronic event including the pick-up location and the predetermined drop-off location.

In accordance with a fifth aspect of the present invention there is provided non-transitory computer-readable medium storing instructions that, when executed by one or more processors, causes the one or more processors to perform a method according to any one of the first, third or fourth aspects.

### BRIEF DESCRIPTION OF THE DRAWINGS

Preferred embodiments of the disclosure will now be described, by way of example only, with reference to the accompanying drawings in which:

FIG. 1 is a schematic illustration of a system for facilitating assistance for services from users within a private online network of users;

FIG. 2 is a process flow diagram illustrating the primary steps in a method for facilitating assistance for services from users within a private online network of users;

FIG. 3 is an example interface for setting up an managing a user profile, as rendered on a screen of a mobile device;

FIG. 4 is a component level diagram of the system of FIG. 1;

FIG. 5 is a series of exemplary screenshots of an example interface rendered on a mobile device for entering information for generating an electronic request;

FIG. 6 is an example electronic alert displayed on a screen of a mobile device;

FIG. 7 is an example calendar event generated from an electronic event; and

FIG. 8 is a series of exemplary screenshots of an example interface rendered on a mobile device for entering information for generating an electronic offer for services.

### DETAILED DESCRIPTION

Described herein are systems and methods for facilitating assistance for services from users within a private online network of users. The system and method will be described with reference to the specific application of assisting parents with the care and transport of children of other parents within a trusted private online network. However, it will be appreciated that the invention has various advantages in other applications such as assisting friends within a trusted network or sporting group. By way of example, the present invention could be used within a group of sailors who regularly require assistance in filling positions on a particular yacht.

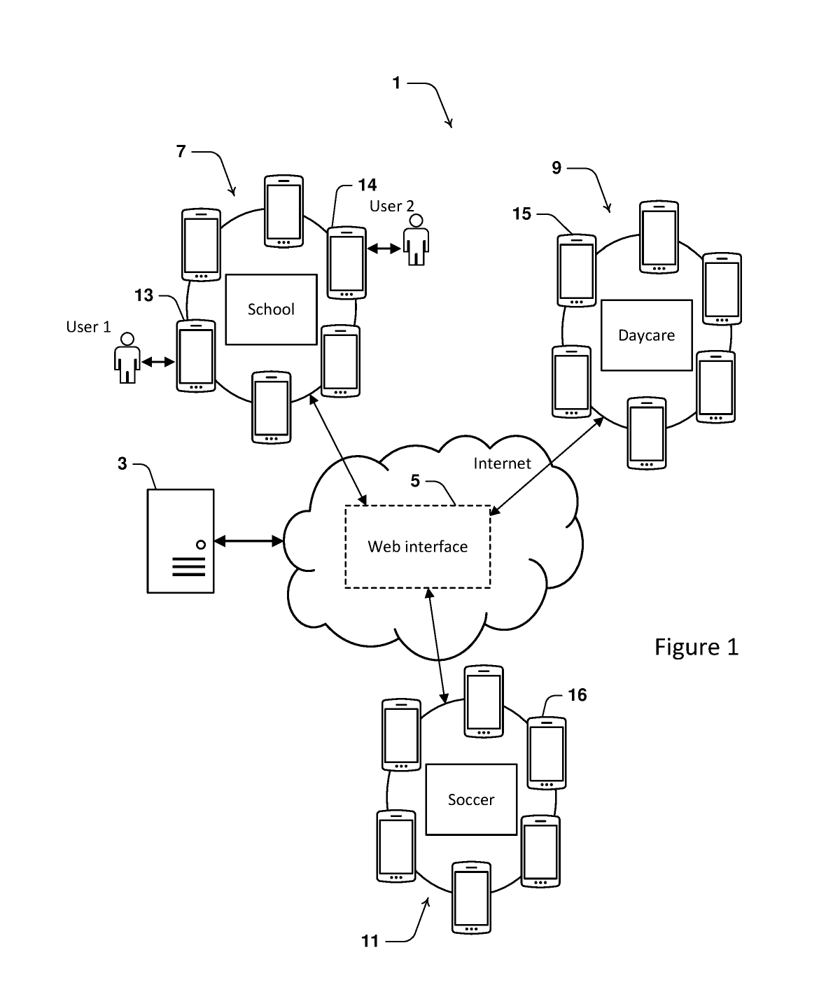

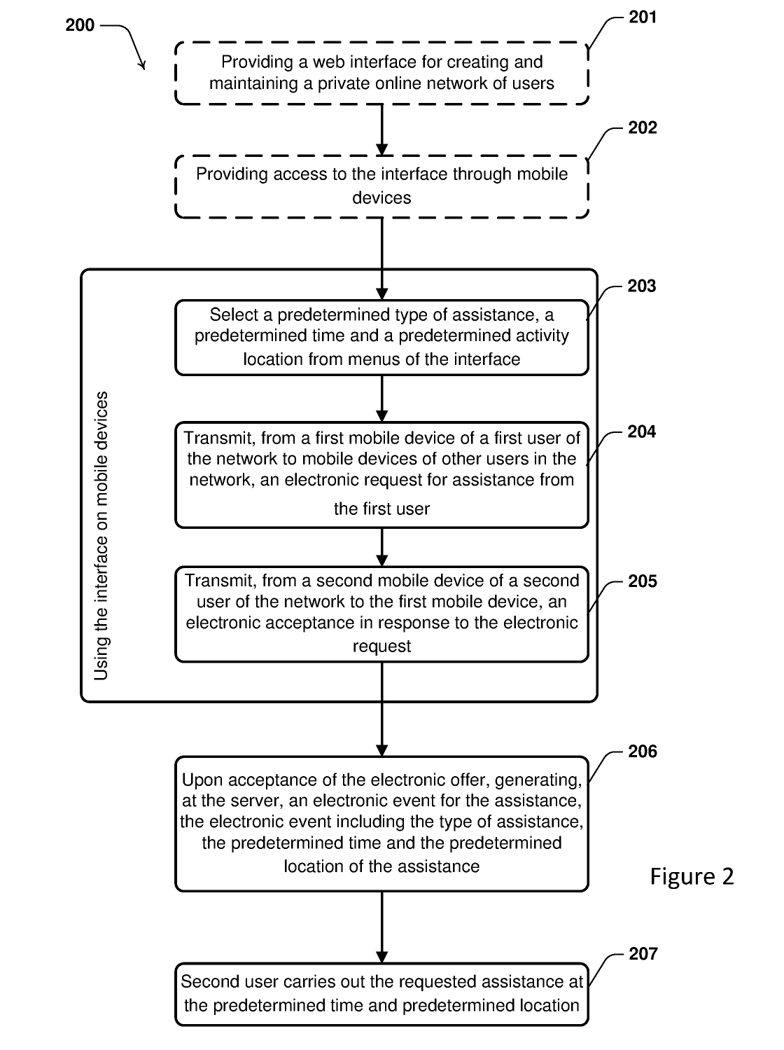

Referring initially to FIG. 1, there is illustrated schematically a system 1 for requesting assistance for services from users within a private online network of users. System 1 is adapted for performing a method 200 as illustrated in FIG. 2. The operation of system 1 will be described with reference to the steps of method 200.

System 1 includes a server 3 for, at step 201, hosting a web interface 5 for creating and maintaining a private online network, e.g. 7, 9, 11, of users seeking or offering assistance in relation to a predetermined service. Exemplary services include picking up children from school or another location and dropping them at a further location, babysitting a child for a period of time or picking up or dropping off another user from a predetermined service location. Unlike other service sharing platforms, in the present invention the users of each private online network are required to have at least one verifiable detail that is common to at least one other user of the private online network. In addition to added security, this allows, for example, the users to be linked by one or more common services such as providing assistance to children of a specific school, grade of school or class, filling a sporting team or assisting other parents with various duties. Server 3 is able to host multiple private online networks (e.g. 7, 9 and 11) simultaneously and users may be members of more than one network.

The private online network represents a private communication link between the subscribed users of that network and permits sending and receiving of data privately. Data may be sent between users as packet data over the internet by Wi-Fi or using mobile packet data in a 3G or greater mobile phone network. In one embodiment, the users of a private online network are linked through their respective mobile devices (E.g. 13-16) using respective mobile phone numbers.

The network can be established by a user (having certain administrator rights) or established by a system administrator. Upon setting up a private online network, the network is allocated a name and may be specified with one or more predefined service locations corresponding to physical addresses of relevant sites of service and/or physical addresses of each user. Alternatively, the users may enter these service locations for subsequent reference. An example service location is a local school where children of the users attend. Another example service location is a sporting ground where children of the users play sport. Multiple service locations may be added for a single private online network.

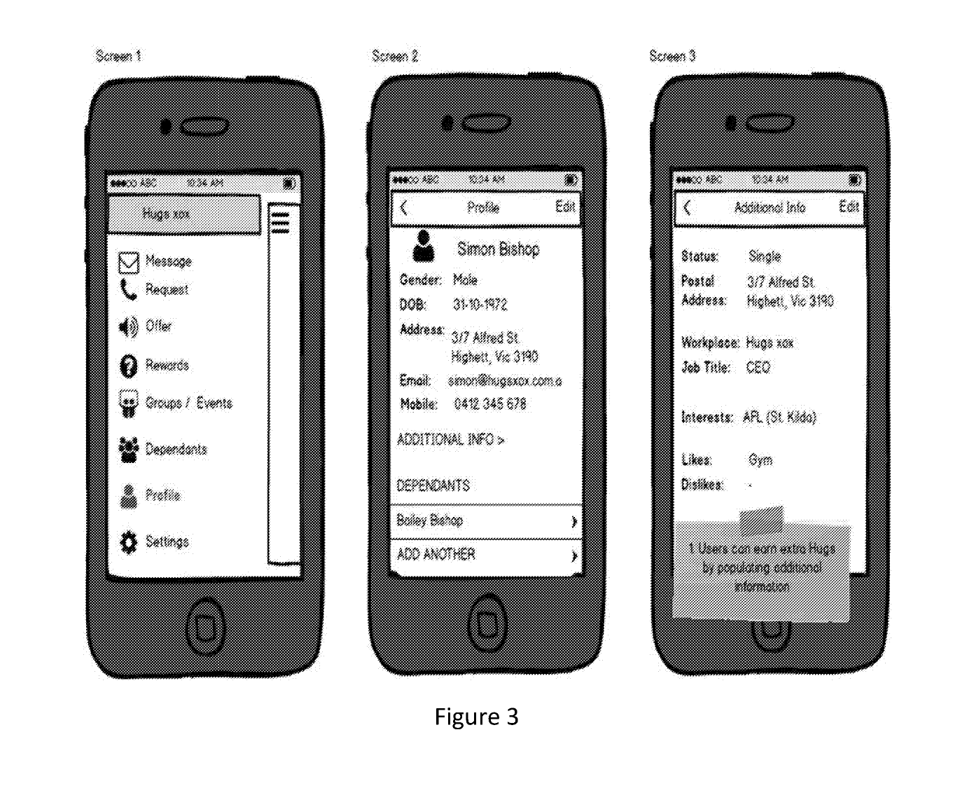

As users are added to the private online network, each user must input required personal information such as their name, age, date of birth, a physical residential address, sex, phone number, email address, their dependents' names, emergency contact details, a photograph, a photograph of their dependents, workplace, job title, interests, likes, vehicle type and colour and various other information. This information is contained within a corresponding user profile for each user. An example interface for setting up an managing a user profile is illustrated in FIG. 3. This exemplary interface is adapted for use on a mobile Smartphone device having a touchscreen interface.

Example information associated with a particular private online network is set out in the table below. Each user is able to register multiple children or dependents.

Each user of a trusted online network is required to have at least one verifiable detail that is common to at least one other user of the private online network. These Examples of these verifiable details include:
Contact details in at least one other member's address book of their mobile device (either with a valid and verifiable mobile phone number or email address);
A verifiable friendship of another member on a social media platform such as Facebook™, Instagram™ or Twitter™ and their account on that platform has verifiable user details; and
A physical address linked to the user or user's child which is common with a physical address linked to at least one other user or a child of at least one other user of the private online network. For example, the children of each member of the trusted online network may share a common school address or other custom address (e.g. swimming pool).

Thus, when a new member is invited to join the private online network, server 3 is configured to access the relevant software applications of the new member's mobile device 13-16 to verify the above user details.

System 1 also includes a plurality of mobile devices (e.g. 13-16) for, at step 202, providing access to web interface 5 to allow users to perform steps 203 to 206, as will be described below. The mobile devices represent Smartphones, tablet computers and other portable electronic devices carried by the users and incorporating mobile web browser software and/or embedded hardware and software for executing proprietary software applications (“Apps”). In some embodiments, interface 5 is able to be accessed by more conventional computer devices such as desktop computers and laptop computers using more conventional web browser software or desktop software applications.

An important aspect of the present invention is security of users and their children. Accordingly, various user verification and authentication checks may be performed on the users. For example, the information within a user profile may be electronically verified with various online databases including a database of police records to confirm the integrity of the users. In some embodiments, the users must agree that their mobile device be tracked through registering their mobile phone number or assigning a unique identifier to the mobile device of a user and verifying that unique identifier at predetermined times. The users may also verify other users through admission of new users to a network and/or through feedback of the users.

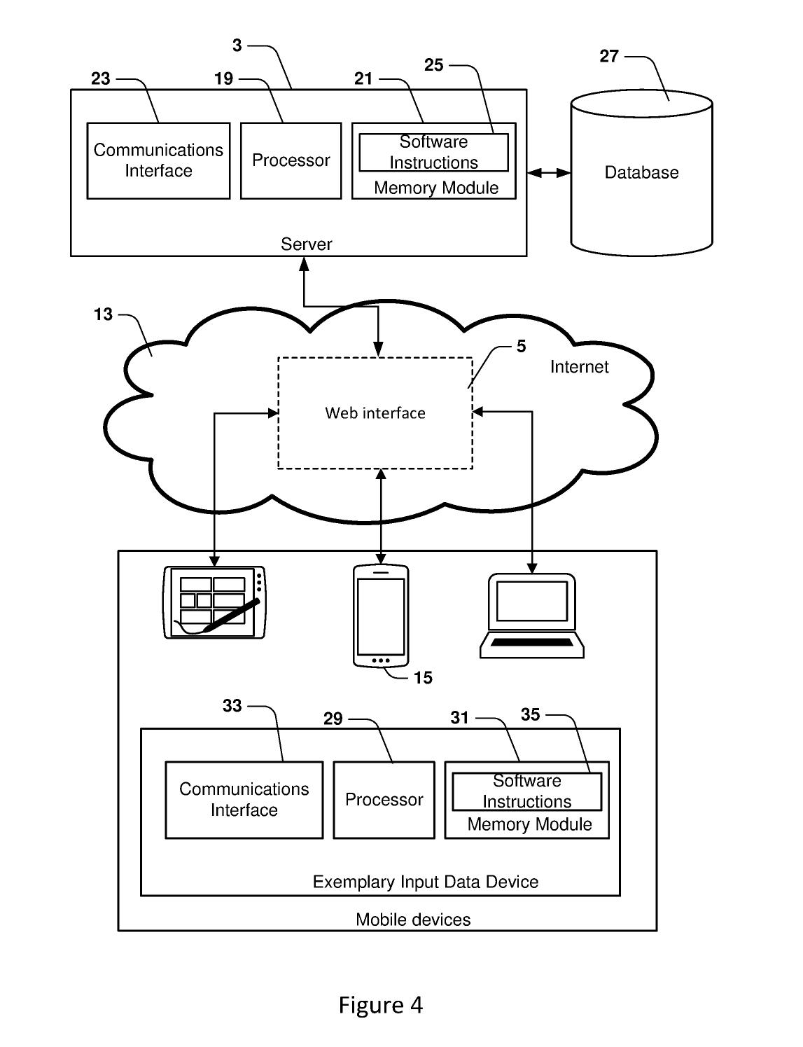

Referring to FIG. 4, system 1 is described in more detail. Server 3 includes a processor 19 coupled to a memory module 21 and a communications interface 23, such as an Internet connection, modem, Ethernet port, wireless network card, serial port, or the like. In other embodiments distributed resources are used. For example, in one embodiment server 3 includes a plurality of distributed servers having respective storage, processing and communications resources. Memory module 21 includes software instructions 25, which are executable on processor 19.

Server 3 is coupled to a database 27. In further embodiments the database leverages memory module 21.

Server 3 is accessed by the users of the private online networks via web interface 5, which includes a mobile device interface such as a proprietary software application (“App”) and may also include one or more browser-renderable websites. The mobile devices used by the users to access server 3 include Smartphones, tablet computers, laptop computers and other mobile computing devices preferably having a touchscreen user interface.

The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided. As will be described below, the interface presented to users may be different to the interface presented to healthcare professionals.

In general terms, each mobile device includes a processor 29 coupled to a memory module 31 and a communications interface 33, such as an internet connection, modem, Ethernet port, serial port, or the like. Memory module 31 includes software instructions 35, which are executable on processor 29. These software instructions allow the mobile devices 13-16 to execute a software application, such as a proprietary application or web browser application and thereby render on-screen a user interface and allow communication with server 3. This user interface allows for the performing of method 200, as well as creation, viewing and administration of user profiles and various other functionalities.

Returning to FIGS. 1 and 2, at step 203, when the user interface is rendered on the screen of a first mobile device 13 corresponding to a first user, the first user is able to select a predetermined type of assistance, a service time and a predetermined service location from menus of the interface. The interface also allows entering of further information such as selecting a particular child which requires assistance and selecting which users of the network from which the assistance is requested.

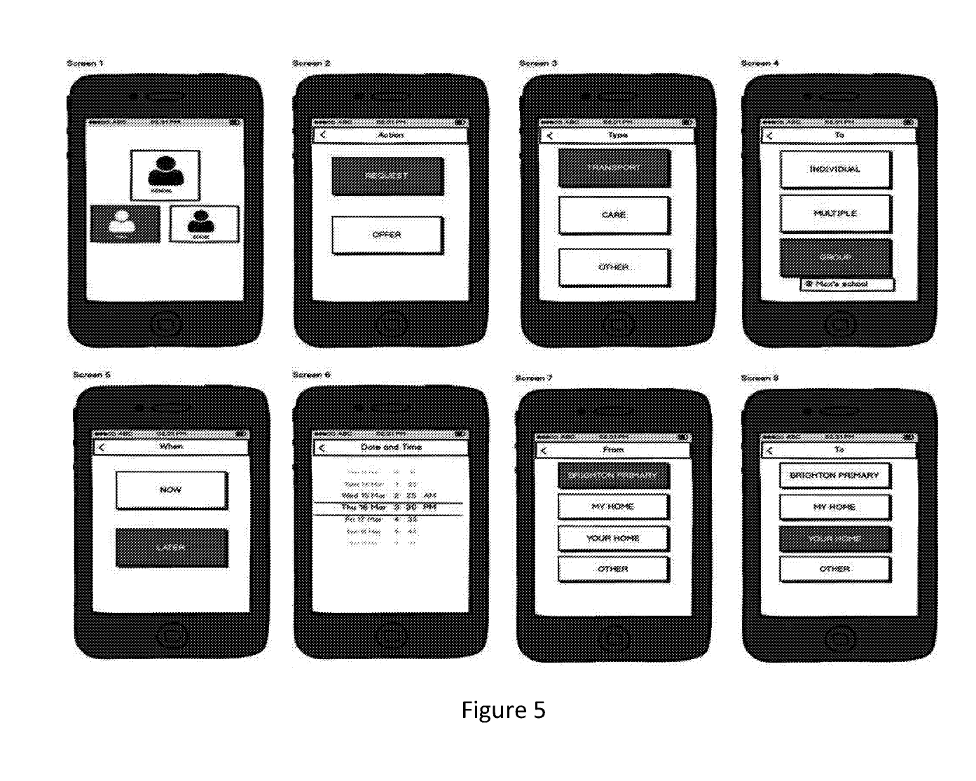

Referring to FIG. 5, there is illustrated a series of exemplary screenshots of an example interface rendered on a mobile device for performing step 203. At screen 1, a particular child is selected from a user's three children. At screen 2, the action of requesting assistance is chosen. The option of offering assistance is also available. At screen 3, a type of assistance is selected from a plurality of predetermined types of assistance including ‘transport’, representing assistance in transporting their child, ‘care’, representing assistance in babysitting their child, and ‘other’ representing other types of predetermined assistance. Predetermined types of assistance are able to be added or removed through a separate menu of the interface. At screen 4, the recipient users of the network are selected from the options of ‘individual’, ‘multiple’ or ‘group’ representing the whole network. At screen 5, the option of requesting assistance ‘now’ or ‘later’ is presented. At screen 6, if ‘later’ is selected at screen 5, the date and time of the requested assistance is able to be entered through a slider type widget. At screen 7, a location of pickup is selected from a plurality of predetermined locations. Finally, at screen 8, a location of drop-off is selected from a plurality of predetermined locations. Predetermined locations are able to be added or removed through a separate menu of the interface.

As illustrated in FIG. 5, the interface includes various menus which are navigated simply through widgets which do not require input of text from the first user. For example, the required information can be entered simply by selecting button widgets or moving a slider widget, all of which can be performed by simple touch gestures on a touchscreen interface of a mobile device. This simple menu navigation is facilitated by the use of predefined types of service and predetermined service locations, which are input during a separate setup procedure. The simplicity in entering the information is helpful for busy users such as parents on the go.

At step 204, the information entered at step 203 is used by server 3 to generate and transmit an electronic request for assistance from first mobile device 13 to mobile devices of other users in the network. If the ‘group’ option is chosen on screen 4 of the exemplary interface illustrated in FIG. 5, then the electronic request is sent to each of the other users of that network. The electronic request includes the information entered in step 203 and optionally other information such as information about the first user. In a simple embodiment, the electronic request includes a type of assistance, a service time and a predetermined location of the required assistance.

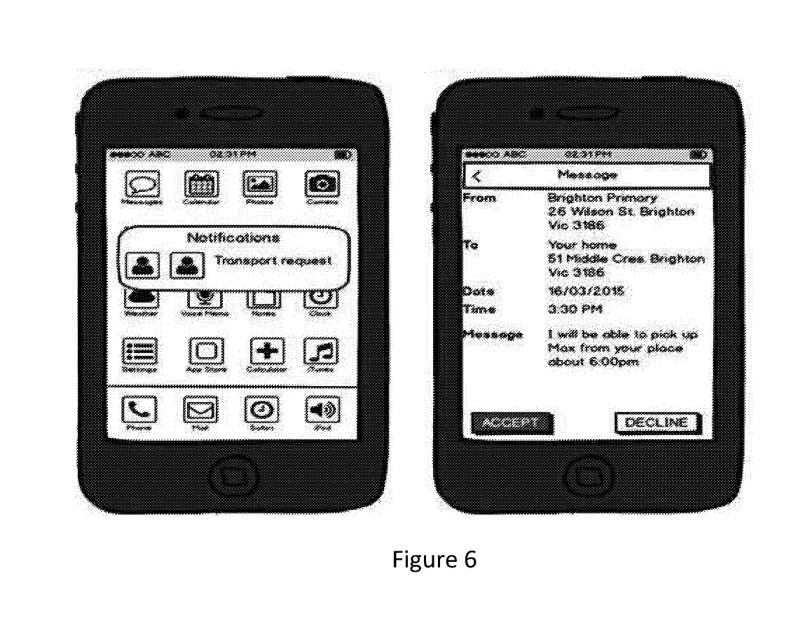

The electronic request is received at the mobile devices of the other users in the network as a notification on the screen of the device. In some embodiments, each user is able to select whether the notifications will be ‘push’ notifications which are displayed automatically upon receipt or ‘pull’ notifications which are only displayed upon user request. In other embodiments, the notification rules are predefined for a network and each member of the network must comply with those rules. An example electronic alert displayed on a screen of a mobile device is illustrated in FIG. 6.

At step 205, a second mobile device 14 of a second user of the network is able to transmit an electronic acceptance to the first mobile device 13 in response to the electronic request. This is facilitated through, for example, ‘Accept’ or ‘Decline’ buttons on the notification screen as illustrated in FIG. 6. In some embodiments, the second user has an option to provide comments or modify the information in the request before sending the acceptance. If multiple users accept the request, the first user to accept the request is allocated the service task. In another embodiment, the first user is able to select which of the accepted users they wish to carry out the service task.

In an alternative embodiment, rather than simply accepting or rejecting the offer, the second user submits an electronic offer in response to the electronic request. The electronic offer is transmitted to the first mobile device 13, where the first user is alerted and is able to accept or reject the electronic offer.

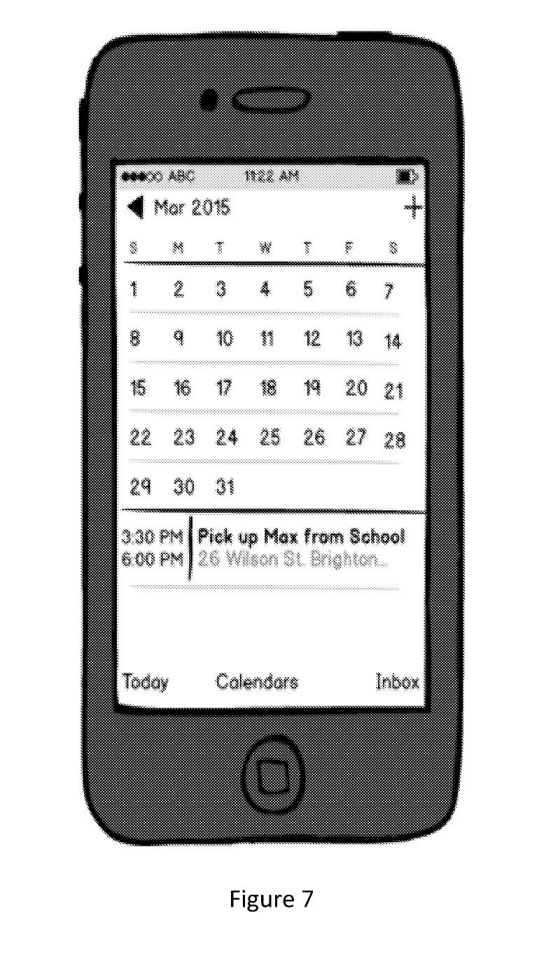

Upon acceptance of the electronic offer, at step 206, the server generates an electronic event for the assistance. The generated electronic event includes details relevant to the required service for the second user including the type of assistance, the pickup and drop off times and the predetermined service location or locations. The electronic event is sent to the second mobile device 14 and stored in memory for access by the second user. The electronic reminder includes further functionality including an electronic calendar entry in an associated calendar/organiser App on the mobile device. An example calendar event generated from an electronic event is illustrated in FIG. 7. The electronic event is able to trigger electronic reminders issued as notifications or alerts on the second mobile device 14 at predetermined times. The electronic event may also include electronic map coordinates for navigating the second user to the predetermined service location to perform the service.

Finally, at step 207, the second user carries out the requested assistance at the predetermined time and predetermined service location. For security, during a period in which the service is taking place, a GPS module of the second mobile device 14 is activated so as to facilitate tracking of the second user by the first user through interface 5. The location of the second mobile device 14 may be stored in database 27 for subsequent review if necessary.

In some embodiments, the private online networks may be linked with affiliated organisations such as local schools. For example, if a child is waiting to be picked up from school, a school staff member is able to access the private online network to identify the individual who is supposed to be picking the child up and to contact that individual or a parent.

Using the predetermined service locations allows for the implementation of an ‘instant pick-up’ feature in which a user generates an electronic request that uses the current GPS position of the GPS device within the user's mobile device as the pick-up location and the current time for the predetermined time input. Using the instant pickup feature, the user simply has to input a desired destination from the predetermined service locations and interface 5 grabs the remaining data from the mobile device. The instant pickup request is immediately sent to the other users within the private online network as an electronic request and displayed as a notification on the mobile devices of the other users. Users willing to assist can respond with a prompt acceptance. If multiple users accept the request, the requesting user is provided with an option to select one of the offers. In this situation, server 3 requests the GPS location of the offering users from their respective mobile devices and interface 5 displays the offers on the screen of the mobile device of the requesting user, together with the distance from the various users. In some embodiments, an estimated time of pick-up is also calculated based on that distance and displayed on the mobile device. In some embodiments, the offering users are able to input an estimated time of pick-up through interface 5.

Interface 5 also includes a user feedback system for providing feedback on the performance of a user in assisting with the service. The feedback is stored against the user's profile and may be available for viewing by other users of that network or may be private. In some embodiments, a rating system is used wherein the availability, punctuality and performance of a user is rated on a fixed scale. Interface 5 is also capable of triggering animations at predetermined events, which are rendered on the display of a user's mobile device. Example events include the acceptance or completion of a requested assistance.

Interface 5 also includes an internal messaging system for sending messages between the users of a private online network.

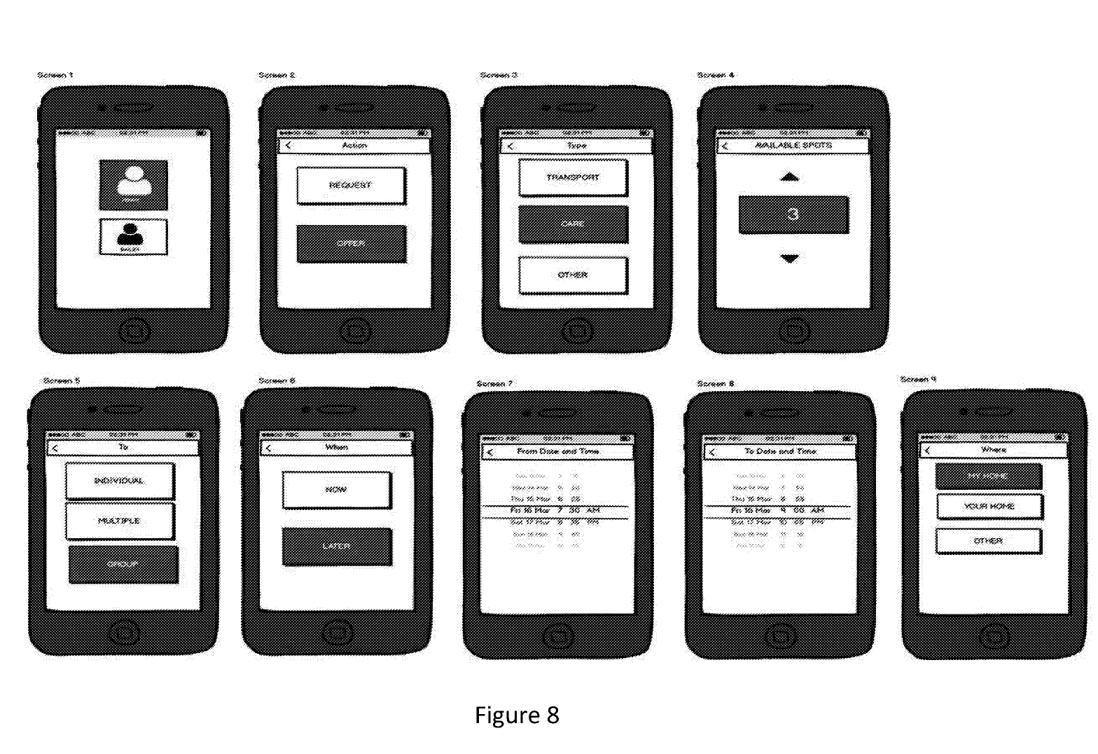

Although system 1 has been described with reference to ‘requesting’ assistance for services, it will be appreciated that the system can also be used to offer assistance for services by following method 200. Referring now to FIG. 8, interface 5 allows for making an offer for assistance for services from users within the private online network. At screen 2, the user selects the ‘Offer’ button to prepare an electronic offer to send other users within the network. At screen 4, a number of available spots for assistance is selected. For example, a user with availability to babysit three children selects ‘3’ available spots. At screens 6 to 9, the service time and predetermined service locations are selected.

To provide incentive for uses to assist with services within the network, interface 5 includes a rewards system in which users can reward other uses with amounts of online credit points which may or may not be linked with a real currency. In one embodiment, each user profile is linked with a corresponding payment facility for making and receiving payments of the online credits upon completion of the requested assistance. For example, the user profile may be linked, via a payment portal, to an associated bank account or credit card to purchase online credit points. The credit points are able to be redeemed for rewards such as cash, vouchers, coupons, donations, gifts or other products obtainable through sponsored entities.

During method 200, the electronic offer may include an offer price in electronic credit points for assisting with the service. Upon completion of the service, a first amount of credit points is deducted from the payment facility of the first user a second amount of credit points is paid to the payment facility of the second user. The first amount is preferably greater than the second amount and the second amount is equal to the offer price. The remainder of the second amount paid by the first user is allocated to a system administrator as a fee and/or to one or more other entities such as the school linked with the network.

In some embodiments, the users are able to counteroffer or bid for service tasks.

### CONCLUSIONS

It will be appreciated that the present invention provides significant advantages in facilitating assistance for services from users within a private online network of users.

The invention helps to extend a parent's trusted network of family and friends by providing them with secure and easy access to a user-friendly private networking interface designed specifically to match/transact and fulfil a requirement or need when it comes to facilitating transport or the care of their children.

The invention incorporates a matching service that connects those in need to those willing to assist within the safety of a trusted private online network; thereby saving the user time, money and stress. The invention provides a facility where trusted users can offer their assistance, not simply send out a request.

The interface automates the process of child management, not only saving time and money but eliminating human error by the creation of reminders through calendar entries and directions via maps.

The inbuilt reward system ensures that the interface not only encourages widespread assistance but also provides a mechanism for rewarding those that do.

The interface is completely adapted for simple generation of requests and offers for assistance through a mobile device interface. This enables, for example, the transport and care of children without the need to type any text. That is, a users can send and accept requests and issue offers for assistance using simple touch gestures through widgets on the interface and without entering text.

The interface allows users to share their geographical location at all times ensuring peace of mind to those parents who have outsourced their care or transport responsibilities.

Security checks performed on users of the private online networks provide further peace of mind and allow the networks to be extended beyond users having direct relationships to a broader network of trusted users who share a common point of interest (school, sport etc.).

### Interpretation

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “controller” or “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of exemplary embodiments of the disclosure, various features of the disclosure are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Thus, while there has been described what are believed to be the preferred embodiments of the disclosure, those skilled in the art will recognize that other and further modifications may be made thereto without departing from the spirit of the disclosure, and it is intended to claim all such changes and modifications as fall within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

We claim:

1. A method for facilitating assistance for services from users within a private online network of users, the method being performed by one or more processors of a server and comprising:
providing a web interface for creating and maintaining a private online network of users seeking or offering assistance in relation to one or more predetermined services, the users of the private online network having at least one verifiable detail that is common to at least one other user of the private online network;
providing access to the interface, through mobile devices, for allowing users to:
(i) select a predetermined type of service, a service time and a predetermined service location from menus of the interface, the predetermined service locations corresponding to physical addresses of relevant sites of service and/or physical addresses of the users of the private online network;
(ii) transmit, from a first mobile device of a first user of the network to mobile devices of other users in the network, an electronic request or offer for assistance from the first user, the request or offer including at least the type of service, the service time and the predetermined service location; and
(iii) transmit, from a second mobile device of a second user of the network to the first mobile device, an electronic acceptance or rejection in response to the electronic request or offer; and
upon acceptance of the electronic request or offer, generating, at the server, an electronic event for the service, the electronic event including the type of assistance, the service time and the predetermined service location.

2. The method according to claim 1, wherein the verifiable detail of a user includes contact details of at least one other user in the user's address book of their mobile device.

3. The method according to claim 1, wherein the verifiable detail of the user includes a friendship on a social media platform with at least one other user of the private online network.

4. The method according claim 1, wherein the verifiable detail of the user includes a physical address linked to the user's child which is common with a physical address linked to a child of at least one other user of the private online network.

5. The method according to claim 1, wherein the electronic event includes an electronic calendar entry.

6. The method according to claim 1, wherein the electronic event includes electronic reminders issued to the second mobile device at predetermined times.

7. The method according to claim 1, wherein the electronic event includes electronic map coordinates for navigating the second user to the predetermined location.

8. The method according to claim 1, wherein, during a period in which the service is taking place, a GPS module of the second mobile device is activated so as to facilitate tracking of the second user by the first user through the interface.

9. The method according to claim 1, wherein steps (i) to (iii) are performed through the interface using only button presses or gestures on predefined menus using touchscreens of the mobile devices.

10. The method according to claim 1, comprising the step of electronically verifying the identity of each user within the network.

11. The method according to claim 10, wherein electronically verifying the identity of each user includes securely accessing a database of police records.

12. The method according to claim 10, wherein electronically verifying the identity of each user includes assigning a unique identifier to a mobile device of a user and verifying that unique identifier at predetermined times.

13. The method according to claim 10, wherein electronically verifying the identity of each user includes identifying a registered phone number associated with a user.

14. The method according to claim 1, wherein the private online network includes parents of children attending a particular school and wherein the predetermined service locations include a physical address of the school.

15. (canceled)

16. The method according to claim 14, wherein the type of assistance includes minding a child of a user within the network at a predetermined location for a predetermined period of time.

17.-18. (canceled)

19. The method according to claim 1, wherein each user has a user profile that is linked with a corresponding payment facility for making and receiving payments of credits upon completion of the requested assistance.

20.-23. (canceled)

24. The method according to claim 1, wherein the menus of the interface do not require input of text from a user.

25. A system for facilitating assistance for services from users within a private online network of users, the system including:
a server hosting a web interface for creating and maintaining a private online network of users seeking or offering assistance in relation to one or more predetermined services, the users of the private online network having at least one verifiable detail that is common to at least one other user of the private online network:
a plurality of mobile devices for accessing the web interface to allow users to:
(i) select a predetermined type of service, a service time and a predetermined service location from menus of the interface, the predetermined service locations corresponding to physical addresses of relevant sites of service and/or physical addresses of the users of the private online network;
(ii) transmit, from a first mobile device of a first user of the network to mobile devices of other users in the network, an electronic request or offer for assistance with the service from the first user, the request or offer including at least the type of service, the service time and the predetermined service location; and
(iii) transmit, from a second mobile device of a second user of the network to the first mobile device, an electronic acceptance or rejection in response to the electronic request or offer; and
wherein, upon acceptance of the electronic request or offer, the server generates an electronic event for the service, the electronic event including the type of assistance, the service time and the predetermined service location.

26. A method for requesting assistance for services from users within a private online network of users, the method being performed by one or more processors of a server and including:
providing a web interface for creating and maintaining a private online network of users seeking or offering assistance in relation to one or more predetermined services, the users of the private online network having at least one verifiable detail that is common to at least one other user of the private online network;
providing access to the interface, through mobile devices, for allowing users to:
(i) select a predetermined type of service, a service time and a predetermined service location from menus of the interface, the predetermined service locations corresponding to physical addresses of relevant sites of service and/or physical addresses of the users of the private online network;
(ii) transmit, from a first mobile device of a first user of the network to mobile devices of other users in the network, an electronic request for assistance from the first user, the request including at least the type of service, the service time and the predetermined service location;
(iii) transmit, from a second mobile device of a second user of the network to the first mobile device, an electronic offer in response to the electronic request; and
(iv) upon receiving the electronic offer, transmit, from the first mobile device to the second mobile device, an acceptance or rejection of the electronic offer; and
upon acceptance of the electronic offer, generating, at the server, an electronic event for the service, the electronic event including the type of assistance, the service time and the predetermined service location.

27. (canceled)

28. A non-transitory computer-readable medium storing instructions that, when executed by one or more processors, causes the one or more processors to perform a method according to claim 1.
